(19) United States
(12) Patent Application Publication
(10) Pub. No.: US 2014/0092339 A1
(43) Pub. Date: Apr. 3, 2014

(54) ILLUMINATION DEVICE AND LIQUID CRYSTAL DISPLAY DEVICE

(71) Applicants: Makoto Yoshimura, Osaka (JP); Syuhei Sota, Yonago-shi (JP)

(72) Inventors: Makoto Yoshimura, Osaka (JP); Syuhei Sota, Yonago-shi (JP)

(73) Assignee: SHARP KABUSHIKI KAISHA, Osaka (JP)

(21) Appl. No.: 14/116,171

(22) PCT Filed: May 7, 2012
(86) PCT No.: PCT/JP2012/002993

§ 371 Date: Nov. 7, 2013

(30) Foreign Application Priority Data
May 12, 2011 (JP) 2011-107322

(51) Int. Cl. F21V 8/00; G02F 1/1335

(52) U.S. Cl. CPC G02B 6/0088; G02B 6/0011; G02F 1/1336
USPC 349/58; 362/615

(57) ABSTRACT

An illumination device has a light guide plate, a sheet section, and a frame. Each optical sheet has projections. The sheet section has a plurality of secured parts each formed by one of the projections or by a plurality of the projections overlapping each other, and the sheet section is secured to the frame at the respective secured parts by a fixing member provided on the side of the sheet section opposite to the light guide plate. The number of projections included in each of the secured parts is fewer than the number of the plurality of optical sheets forming the sheet section.

### TECHNICAL FIELD

The present invention relates to an illumination device and a liquid crystal display device provided therewith.

### BACKGROUND ART

Electronics such as mobile phones, for example, have recently come to widely adopt liquid crystal display devices as display devices. In particular, transmissive liquid crystal display devices have a liquid crystal display panel, a backlight unit that is an illumination device arranged facing this liquid crystal display panel, and a frame that houses this liquid crystal display panel and backlight unit. The backlight unit has a light guide plate facing the liquid crystal display panel, and optical sheets provided between the light guide plate and the liquid crystal display panel. The optical sheets are sheets for controlling the optical characteristics of light that is incident on the optical sheets.

The optical sheet is generally made of a resin material, and thus easily expands or becomes deformed due to changes in temperature and the like. If the entirety of each of the optical sheets is secured to the frame, the liquid crystal display panel, or the like, then there is a problem in which the expansion or deformation of the optical sheets will cause the sheet section to warp, resulting in diminished display quality.

As a countermeasure, a configuration is disclosed in Patent Document 1 in which projections are formed in several locations on a substantially rectangular optical sheet, and only these projecting parts of the optical sheet are adhesively attached to the frame by double-faced tape. This leads to fewer restricted areas on the optical sheet, and therefore, it is possible for the optical sheets to be less susceptible to warping even if the optical sheets expand due to heat.

### RELATED ART DOCUMENT

### Patent Document

Patent Document 1: Japanese Patent Application Laid-Open Publication No. 2009-122167

### SUMMARY OF THE INVENTION

### Problems to be Solved by the Invention

A plurality of optical sheets are normally stacked together in a liquid crystal display device. The plurality of optical sheets form a sheet section. A plurality of projections on the optical sheets form a secured part of the sheet section.

However, in the liquid crystal display device described above in Patent Document 1, the energy of the light that is emitted from the light guide plate and then incident on the vicinity of the secured parts of the sheet section is absorbed by the fixing member such as the double-faced tape, and thus some of the energy is lost, resulting in the brightness of the transmitted light being lowered in the vicinity of the secured part. As a result, dark spots occur in several areas on the display screen, leading to a lowering of display quality.

On the other hand, if the number of secured parts on the sheet section is decreased, then the securing strength of the sheet section becomes difficult to maintain.

The present invention was made in view of the above, and aims at suppressing decreased brightness of the transmitted light in the vicinity of the secured parts, while maintaining the securing strength of the secured parts on the sheet section.

### Means for Solving the Problems

In order to achieve the above-mentioned aims, an illumination device according to the present invention is provided with: a light guide plate that has a light-exiting surface from which guided light exits; a sheet section that is arranged on the light-exiting side of the light guide plate and that has a plurality of optical sheets stacked together; and a frame that holds the sheet section and light guide plate, wherein each optical sheet has projections that project over the light-exiting surface of the light guide plate along a surface of the respective optical sheet, wherein the sheet section has a plurality of secured parts each including one of the projections or a plurality of the projections overlapping each other, the sheet section being secured to the frame at the respective secured parts by a fixing member provided on a side of the sheet section opposite to the light guide plate, and wherein the number of projections constituting the respective secured parts is fewer than a number of the plurality of optical sheets constituting a sheet section.

With this configuration, the sheet section is secured to the frame at the plurality of secured parts, and thus the securing strength thereof can be suitably maintained. Furthermore, the entire periphery of the sheet section is not secured to the frame, but rather the sheet section is secured to the frame at the plurality of secured parts, and thus, the restricted areas of the sheet section are fewer, resulting in less susceptibility to warping of the sheet section even if the sheet section expands due to heat.

Some of the light that is emitted from the light guide plate is lost as the light passes through the sheet section. The degree of light that is lost becomes greater the more optical sheets there are. In the present invention, the number of projections on the optical sheets forming the secured parts is fewer than the number of optical sheets forming the entire sheet section. Accordingly, the degree of light that is lost when the light passes through the vicinity of the secured parts can be decreased more than the degree of light that is lost when the light passes through other areas of the sheet section. Therefore, even if the energy of the light that passes through the secured parts is absorbed by the securing member, the degree of transmitted light that is lost due to the secured parts is relatively small, and thus, a decrease in brightness of the transmitted light in the vicinity of the secured parts can be suppressed. Therefore, dark spots can be eliminated in the vicinity of the secured parts, and a uniform amount of light can be emitted from the illumination device.

The liquid crystal display device of the present invention has a liquid crystal display panel, and the illumination device arranged facing the liquid crystal display panel. With this configuration, dark spots in the vicinity of the secured parts can be prevented from occurring, and the display quality can be increased.

### Effects of the Invention

According to the present invention, the sheet section is secured to the frame at the plurality of secured parts, and thus, can suppress warping of the sheet section due to thermal expansion, while suitably maintaining securing strength of the sheet section to the frame. The number of projections on the optical sheets forming the secured parts is fewer than the number of optical sheets forming the entire sheet section, and therefore, the degree of transmitted light that is lost due to the secured parts is low, resulting in the ability to suppress decreased brightness of transmitted light in the vicinity of the secured parts. Thus, dark spots can be prevented in the vicinity of the secured parts, and uniform light can be emitted from the illumination device.

### BRIEF DESCRIPTION OF THE DRAWINGS

FIG. 1 is a plan view showing a sheet section secured to a frame in Embodiment 1.

FIG. 2 is a cross-sectional view of the liquid crystal display device along the line II-II in FIG. 1.

FIG. 3 is a cross-sectional view of the liquid crystal display device along the line III-III in FIG. 1.

FIG. 4 is a cross-sectional view showing a part of FIG. 3 that has been magnified.

FIG. 5 is a plan view showing a configuration of a third optical sheet.

FIG. 6 is a plan view showing a configuration of a second optical sheet.

FIG. 7 is a plan view showing a configuration of a first optical sheet.

FIG. 8 is a cross-sectional view showing a magnified part of a liquid crystal display device according to a comparison example.

FIG. 9 is a cross-sectional view showing a magnified part of a liquid crystal display device according to a comparison example.

FIG. 10 is a cross-sectional view showing a magnified part of a liquid crystal display device according to Embodiment 2.

FIG. 11 is a table showing results of actually observed uniformity of illumination light.

FIG. 12 is a plan view showing a sheet section secured to a frame in Embodiment 3.

FIG. 13 is a plan view showing a first optical sheet section secured to a frame in Embodiment 3.

FIG. 14 is a cross-sectional view along the line XIV-XIV in FIG. 12.

FIG. 15 is a plan view showing a configuration of a second optical sheet.

FIG. 16 is a plan view showing a configuration of a first optical sheet.

### DETAILED DESCRIPTION OF EMBODIMENTS

Embodiments of the present invention will be described in detail below with reference to drawings. The present invention is not limited to the embodiments below.

### Embodiment 1

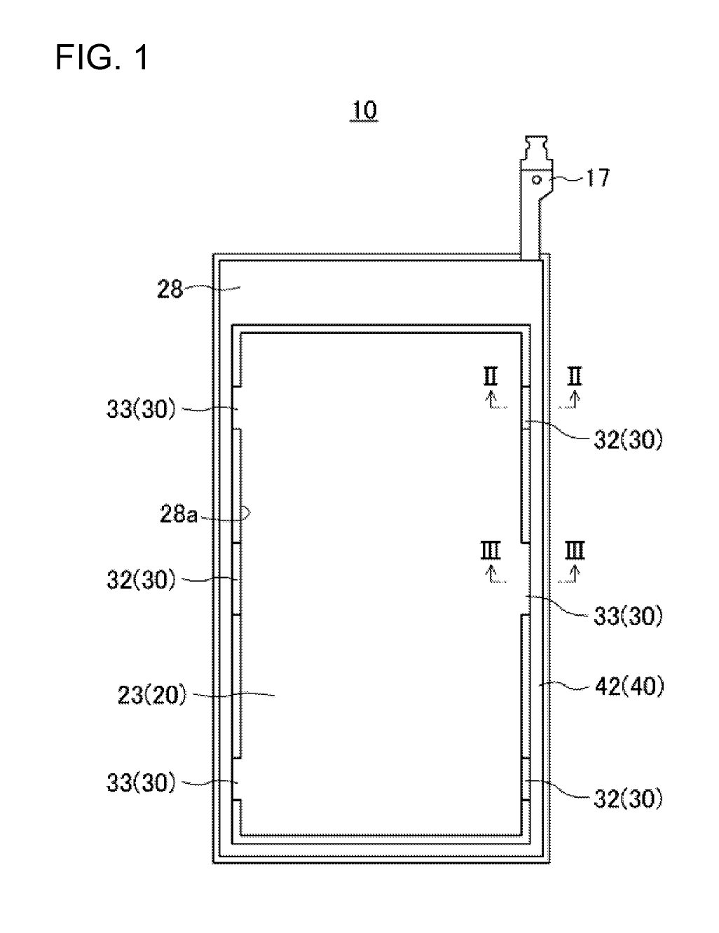

FIGS. 1 to 7 show Embodiment 1 of the present invention.

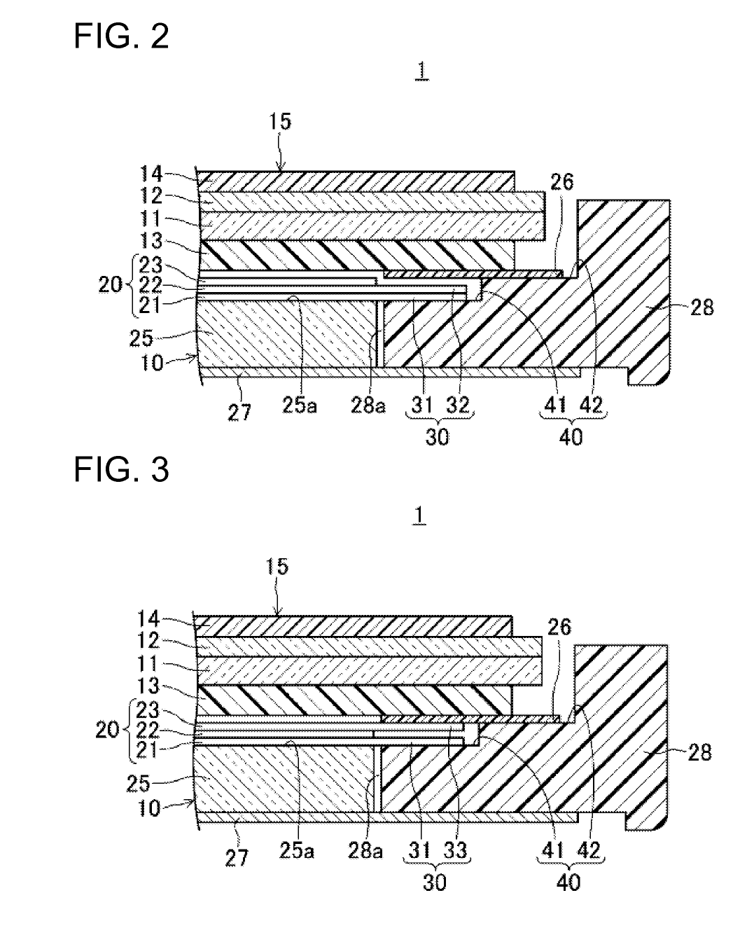

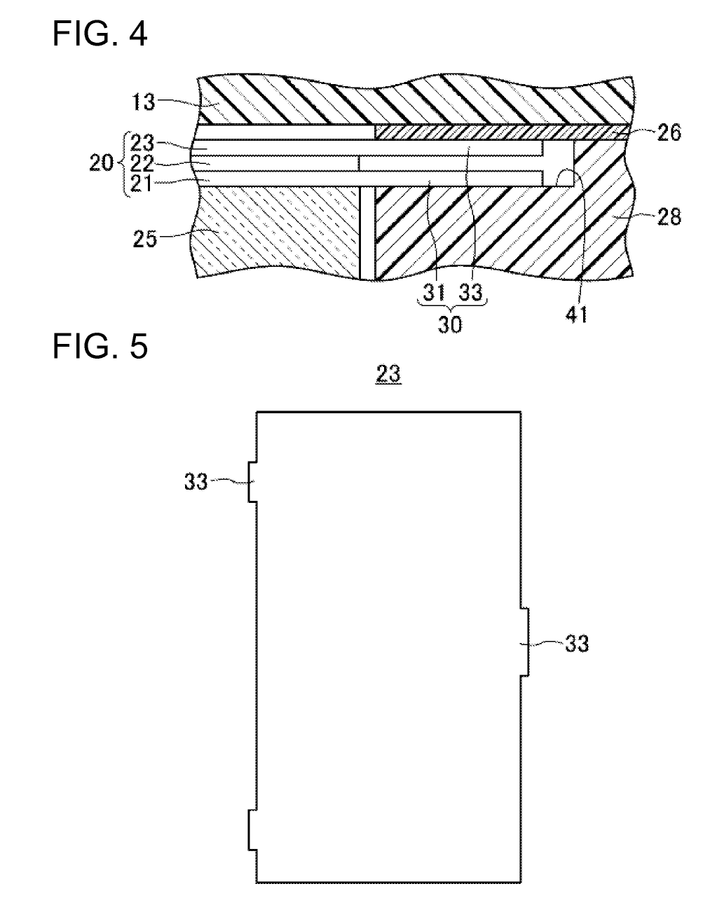

FIG. 1 is a plan view showing a sheet section 20 secured to a frame 28 in Embodiment 1. FIG. 2 is a cross-sectional view of a liquid crystal display device 1 along the line II-II in FIG. 1. FIG. 3 is a cross-sectional view of the liquid crystal display device 1 along the line III-III in FIG. 1. FIG. 4 is a cross-sectional view showing a part of FIG. 3 that has been magnified. FIGS. 5 to 7 are plan views showing configurations of optical sheets 21, 22, and 23.

(Liquid Crystal Display Device)

As shown in FIGS. 2 and 3, the liquid crystal display device 1 has a liquid crystal display panel 15, and a backlight unit 10 that is an illumination device arranged facing the liquid crystal display panel 15.

The liquid crystal display panel 15 has a TFT substrate 11 as an active matrix substrate, an opposite substrate 12 arranged facing the TFT substrate 11, and a liquid crystal layer (not shown) provided between the TFT substrate 11 and the opposite substrate 12. A polarizing plate 13 is attached to the TFT substrate 11 on the side opposite to the opposite substrate 12. A polarizing plate 14 is attached to the opposite substrate 12 on the side opposite to TFT substrate 11.

(Backlight Unit)

As shown in FIGS. 2 and 3, the backlight unit 10 is provided with a light guide plate 25 having a light-exiting surface 25a where guided light exits from, the sheet section 20 arranged on the light-exiting surface 25a side of the light guide plate 25, and the frame 28 that holds the sheet section 20 and light guide plate 25.

(Frame)

The frame 28 is made of a resin, and as shown in FIG. 1, the frame 28 is formed in a rectangular frame shape that has a rectangular opening 28a. A cut-out part 40 is formed inside the frame 28 so as to surround the opening 28a. As shown in FIGS. 2 and 3, the cut-out part 40 has: a plurality of first support surfaces 41 that are formed on an inner edge of the frame 28 and that have a height around the same as the surface of the light guide plate 25 on the liquid crystal display panel 15 side; and a second support surface 42 that is further out on the frame 28 than the first support surfaces 41 and that is formed so as to surround the opening 28a, the second support surface 42 being formed as a step surface that is higher on the liquid crystal display panel 15 than the first support surfaces 41.

In the present embodiment, the first support surfaces 41 are formed in a rectangular shape, but the present invention is not limited thereto, and the first support surfaces 41 may be another shape.

A reflective plate 27 is attached to the frame 28 on the side opposite to liquid crystal display panel 15. In this way, the opening 28a of the frame 28 is blocked by the reflective plate 27.

The rectangular light guide plate 25 is placed on the reflective plate 27 in the opening 28a of the frame 28. An optical pattern (not shown) for guiding emitted light in the normal direction of the liquid crystal display panel 15 is formed on the light-exiting surface 25a of the light guide plate 25.

A plurality of light-emitting diodes (number shown is approximate), which are light sources, are arranged on the frame 28 so as to face a light-incident surface (not shown), which is one side face of the light guide plate 25. As shown in FIG. 1, a flexible substrate 17 that supplies power and the like is connected to these light-emitting diodes.

(Sheet Section)

The rectangular sheet section 20 that has substantially the same size as the light-exiting surface is placed on the light-exiting surface 25a, which is a surface opposite to the reflective plate 27 of the light guide plate 25. The sheet section 20 has a plurality of optical sheets 21, 22, and 23 stacked together. The sheet section 20 of the present embodiment has three optical sheets: the first optical sheet 21, the second optical sheet 22, and the third optical sheet 23, for example. The optical sheets are sheets for controlling the optical characteristics of light that is incident on a prism sheet, diffusion sheet, and the like, for example.

As shown in FIGS. 2 to 5, the first to third optical sheets 21, 22, and 23 are formed in a substantially rectangular shape, and have respective projections 31, 32, and 33 that project over the light-exiting surface 25a of the light guide plate 25 towards a direction along the surface of the optical sheets 21, 22, and 23. Each projection 31, 32, and 33 is formed in a rectangular shape.

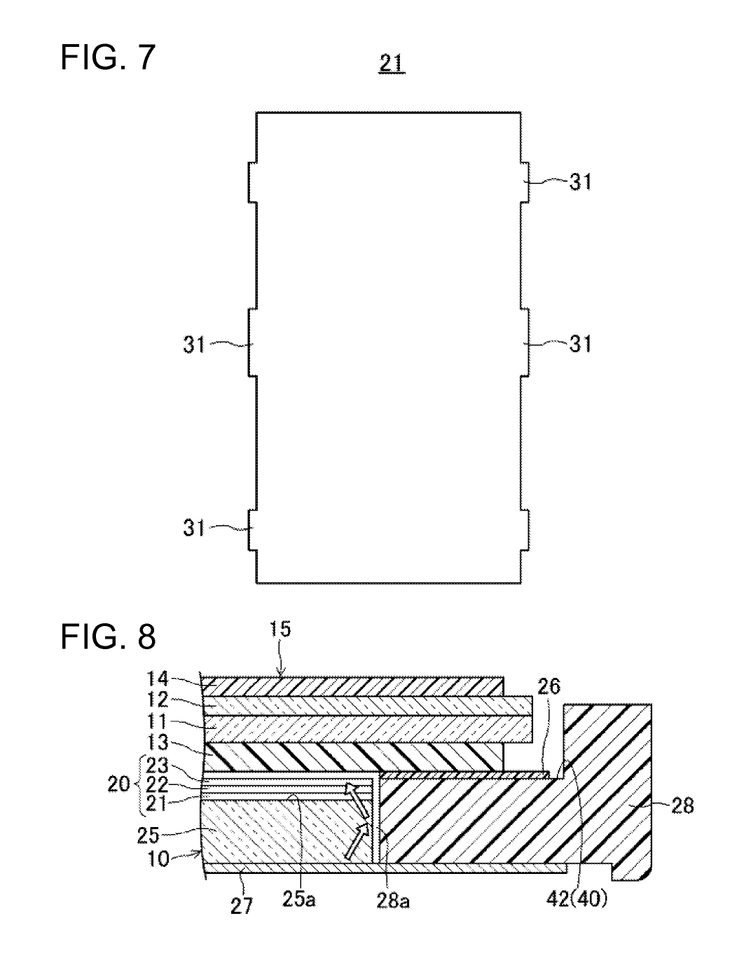

The first optical sheet 21 is placed on the light-exiting surface 25a of the light guide plate 25, and has six projections 31, for example, as shown in FIG. 7. There are three projections 31 provided on each long-side of the first optical sheet 21, and these projections 31 are placed apart from each other.

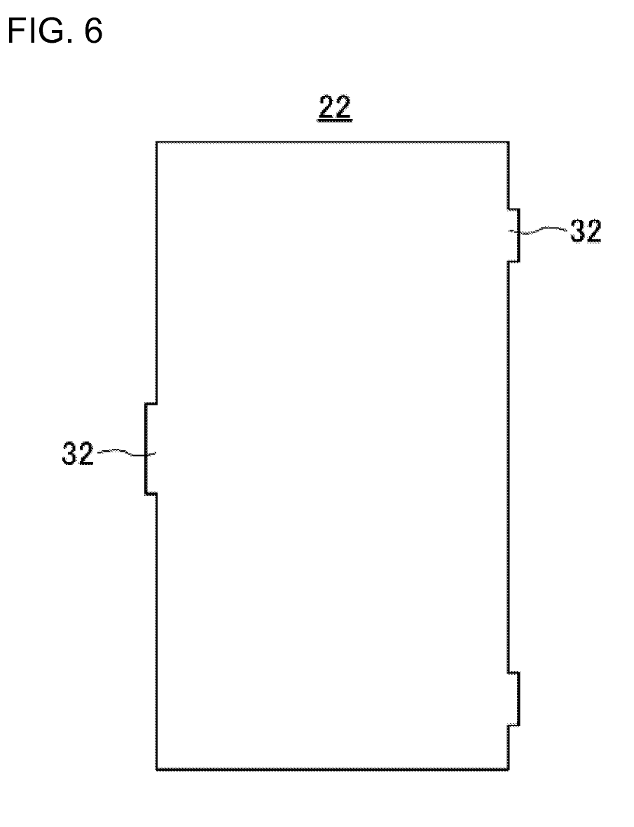

The second optical sheet 22 is stacked on the liquid crystal display panel 15 side of the first optical sheet 21, and has three projections 32, for example, as shown in FIG. 6. There are two projections 32 on one long-side of the second optical sheet 22, and one projection 32 on the other long-side of second optical sheet 22. Each respective projection 32 overlaps any one of the projections 31 while the second optical sheet 22 is stacked on the first optical sheet 21.

The third optical sheet 23 is stacked on the liquid crystal display panel 15 side of the second optical sheet 22, and has three projections 33, for example, as shown in FIG. 5. There are two projections 33 on one long-side of third optical sheet 23, and one projection 33 on the other long-side of third optical sheet 23. Each projection 33 overlaps each of the projections 31 without overlapping the projections 32 when the third optical sheet 23 overlaps the first and second optical sheets 21 and 22.

In this way, the sheet section 20 has a plurality of secured parts 30 including the plurality of mutually-overlapping projections 31, 32, and 33. In other words, as shown in FIG. 2 the sheet section 20 has the secured parts 30 including the first projections 31 and second projections 32, and as shown in FIG. 3, the secured parts 30 including the first projections 31 and third projections 33.

Accordingly, each secured part 30 has a mutually identical number of projections 31, 32, and 33. The number of projections 31, 32, and 33 constituting each of the secured parts 30 is 2, which is fewer than the number of the plurality of optical sheets 21, 22, and 23 that form the sheet section 20.

As shown in FIGS. 2 to 4, the secured parts 30 of the sheet section 20 are supported by the first support surfaces 41 of the frame 28. A double-faced adhesive tape 26, which is a fixing member, is provided on the side of the sheet section 20 that is opposite to the light guide plate 25. The double-faced adhesive tape 26 is formed in a rectangular frame shape, for example, and is adhesively supported by the second support surface 42 of the frame 28. The sheet section 20 is secured to the frame 28 at the secured parts 30 by the double-faced adhesive tape 26.

The liquid crystal display panel 15 is adhesively attached to the second support surface 42 of the frame 28 via the double-faced adhesive tape 26, in a state in which the liquid crystal display panel 15 is arranged facing the light guide plate 25 and the sheet section 20. In this way, a liquid crystal display device 1 is formed.

The liquid crystal display device 1 supplies illumination light from the backlight unit 10 to the liquid crystal display panel 15, and display is performed by this illumination light being selectively transmitted in the liquid crystal display panel 15.

In other words, the light from the plurality of light-emitting diodes, which are light sources, is incident on the light guide plate 25 from the light-incident surface. The light incident on the light guide plate 25 is diffused and guided inside the light guide plate 25. The light that exits to the rear side of the light guide plate 25 is reflected by the reflective plate 27 and is incident on the light guide plate 25. In this way, illumination light with a brightness that has been made uniform exits from the light-exiting surface of the light guide plate 25. The light that exits the light guide plate 25 has the optical characteristics thereof controlled by the sheet section 20, supplied thereafter to the liquid crystal display panel 15, and then provided for a desired display.

### Effects of Embodiment 1

Thus, according to Embodiment 1, the sheet section 20 is secured to the frame 28 at the plurality of secured parts 30, and thus the securing strength thereof can be suitably maintained. The entire area surrounding the sheet section 20 is not secured to the frame 28, but rather is secured to the frame 28 at the plurality of secured parts 30, which reduces the number of restricted areas of the sheet section 20. This makes it possible for the sheet section 20 to be less susceptible to warping even if the sheet section 20 has expanded due to heat.

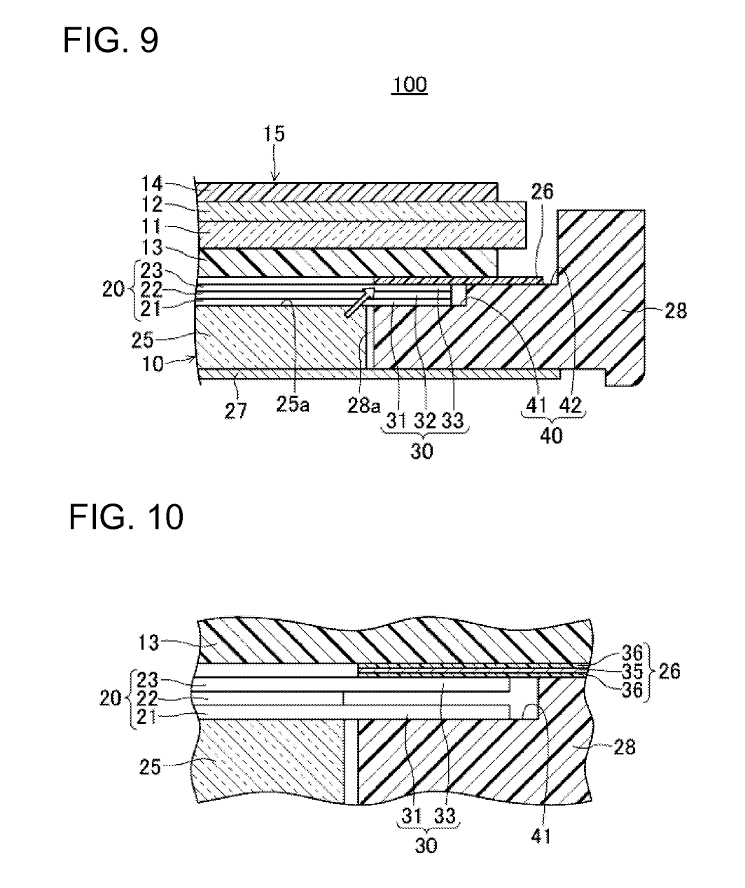

FIGS. 8 and 9 are cross-sectional views showing a magnified part of a liquid crystal display device 100 according to comparison examples. As shown in FIGS. 8 and 9, the liquid crystal display 100 of the comparison example differs from the liquid crystal display device 1 of the present embodiment in the configuration in the vicinity of the secured parts 30 of the sheet section 20. In the liquid crystal display device 100 of this comparison example, the secured parts 30 are formed by the same number of projections 31, 32, and 33 as the number of optical sheets 21, 22, and 23 forming the sheet section 20.

As shown in FIG. 8, in the areas of the frame 28 where the first support surface 41 is not formed, the light emitted from the light guide plate 25 is reflected by the inner wall of the frame 28, as shown by the arrows in FIG. 8. This results in the light passing through the sheet section 20 without being absorbed by the double-faced adhesive tape 26. As shown in FIG. 9, in the areas of the frame 28 where the first support surface 41 is formed, a portion of the light emitted from the light guide plate 25 passes through the secured parts 30 and is incident on the double-faced adhesive tape 26, as shown by the arrow in FIG. 9. This causes a portion of the energy of the light to be absorbed by the double-faced adhesive tape 26 in areas near these secured parts 30, and thus brightness of the illumination light is lowered. As a result, the illumination light in the vicinity of the secured parts 30 is darker than other areas.

As a countermeasure, in the present embodiment, the number of projections 31, 32, and 33 on the optical sheets 21, 22, and 23 forming the secured parts 30, as described above, is fewer than other areas, and therefore dark spots such as those in the comparison example can be prevented from occurring.

In other words, some of the light emitted from the light guide plate 25 is lost as the light passes through the sheet section 20. The degree of light that is lost increases as the number of optical sheets 21, 22, and 23 increases. In the present embodiment, the number of projections 31, 32, and 33 of the optical sheets 21, 22, and 23 forming the secured parts 30 is fewer than the number of optical sheets 21, 22, and 23 that form the entire sheet section 20. Accordingly, the degree of light that is lost when the light passes through the vicinity of the secured parts 30 can be decreased more than the degree of light that is lost when the light passes through other areas of the sheet section 20. Therefore, even if the energy of the light that passes through the secured parts 30 is absorbed by the double-faced adhesive tape 26, the degree of transmitted light that is lost due to the secured parts 30 is relatively small, and thus a decrease in brightness of the transmitted light in the vicinity of the secured parts 30 can be suppressed. As a result, dark spots can prevented from occurring in the vicinity of the secured parts 30, and uniform light can be emitted from the backlight unit 10. In this way, the display quality of the liquid crystal display device 1 can be increased.

Each secured part 30 has the same number of projections 31, 32, and 33, and thus the degree of transmitted light that is lost at each secured part 30 is the same, allowing the brightness of illumination light to be made more uniform.

### Embodiment 2

FIG. 10 shows Embodiment 2 of the present invention.

FIG. 10 is a cross-sectional view showing a magnified part of a liquid crystal display device according to Embodiment 2. In each embodiment below, parts that are the same as FIGS. 1 to 9 are assigned the same reference characters and detailed descriptions thereof will be omitted.

Embodiment 2 differs from the liquid crystal display device 1 and the backlight unit 10 in Embodiment 1 in that the configuration of the double-faced adhesive tape 26 has been changed.

As shown in FIG. 10, double-faced adhesive tape 26 in Embodiment 2 has a reflective layer 35 that reflects light that passes through a sheet section 20, and resin layers 36 stacked on the reflective layer 35. ESR (brand name) by Sumitomo 3M Limited, or a tape or the like with silver deposited on the surface thereof can be used for such a double-faced adhesive tape 26, for example. Therefore, according to the double-faced adhesive tape 26 of the present embodiment, the reflectance of the light that has passed through the secured parts 30 can be increased, and therefore the degree of energy of the light that is lost can be substantially decreased.

It is possible to make the color of the double-faced adhesive tape 26 white, as another configuration of the double-faced adhesive tape 26. The reflectance of transmitted light of the secured parts 30 can be increased even if the color of the double-faced adhesive tape is made white, and thus the occurrence of dark spots in the vicinity of the secured parts 30 can be suppressed.

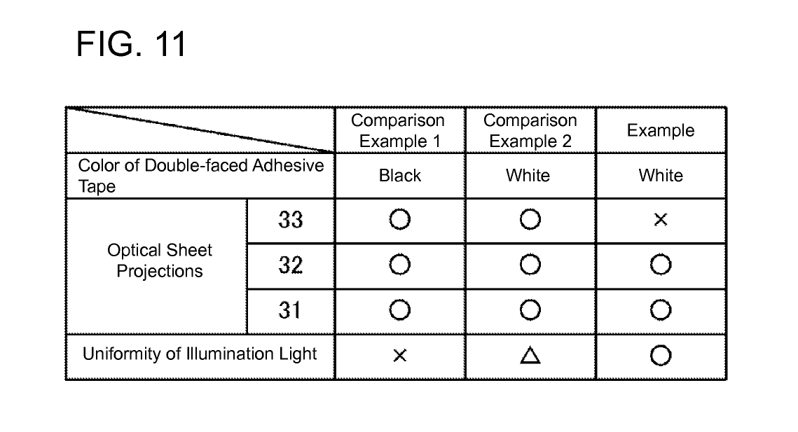

FIG. 11 is a table showing the results of uniformity of illumination light that has been actually observed. In liquid crystal display devices having the secured parts 30 with the three projections 31, 32, and 33, the liquid crystal display with black double-faced adhesive tape 26 is Comparison Example 1, and the liquid crystal display device with white double-faced adhesive tape 26 is Comparison Example 2. The liquid crystal display device with two secured parts 30 having two projections 31 and 32, and white double-faced adhesive tape 26 is an Example.

The ∘ symbol in the “Optical Sheet Projections” field in FIG. 11 represents the presence of projections, and the x symbol represents the absence of projections. The ∘ symbol in the “Uniformity of Illumination Light” field in FIG. 11 represents the highest level of uniformity of illumination light, the x symbol represents the lowest level of uniformity of illumination light, and the Δ symbol represents a uniformity of illumination light that is higher than x but lower than ∘.

As shown in FIG. 11, in Comparison Example 1 dark spots occurred markedly in the vicinity of the secured parts 30, and the uniformity of illumination light was relatively low. This is due to the energy of light, which has already been reduced due to the three projections 31, 32, and 33 forming the secured parts 30, being further absorbed by the double-faced adhesive tape 26.

In Comparison Example 2, the dark spots were visible in the vicinity of the secured parts 30, and while the uniformity of illumination light is higher than in Comparison Example 1, it cannot be said to be good. The reason why the uniformity of illumination light is higher is that while some of the light is lost due to the three projections 31, 32, and 33 forming the secured parts 30, the double-faced adhesive tape 26 is white, and therefore the amount of energy of light absorbed by the double-faced adhesive tape 26 was reduced.

On the other hand, in the Example, dark spots were not visible in the vicinity of the secured parts 30, and the uniformity of illumination light was relatively high. This is because the number of projections 31 and 32 forming the secured parts 30 is fewer than the number of optical sheets 21, 22, and 23 in other areas of the sheet section 20, and thus leading to a relative reduction in the degree of transmitted light that is lost at the vicinity of the secured parts 30. Furthermore, the double-faced adhesive tape 26 is white, and therefore the absorption of energy of the light by the double-faced adhesive tape 26 is reduced.

### Effects of Embodiment 2

Accordingly, Embodiment 2 can also suppress warping of the sheet section 20 due to thermal expansion while suitably maintaining a securing strength for the frame 28 of the sheet section 20, due to the sheet section 20 being secured to the frame 28 at the plurality of secured parts 30. The number of projections 31, 32, and 33 on the optical sheets 21, 22, and 23 forming the secured parts 30 is fewer than the number of optical sheets 21, 22, and 23 forming the entire sheet section 20, resulting in a smaller degree of transmitted light that is lost at the secured parts 30, and making it possible to suppress a reduction in brightness of transmitted light in the vicinity of these secured parts 30. Therefore, dark spots are can be prevented from occurring in the vicinity of the secured parts 30, and uniform light can be emitted from backlight unit 10. In this way, the display quality of a liquid crystal display device 1 can be increased.

Since the double-faced adhesive tape 26 is white or has the reflective layer 35, the energy of light absorbed by the double-faced adhesive tape 26 is reduced, and the uniformity of illumination light can be increased.

### Embodiment 3

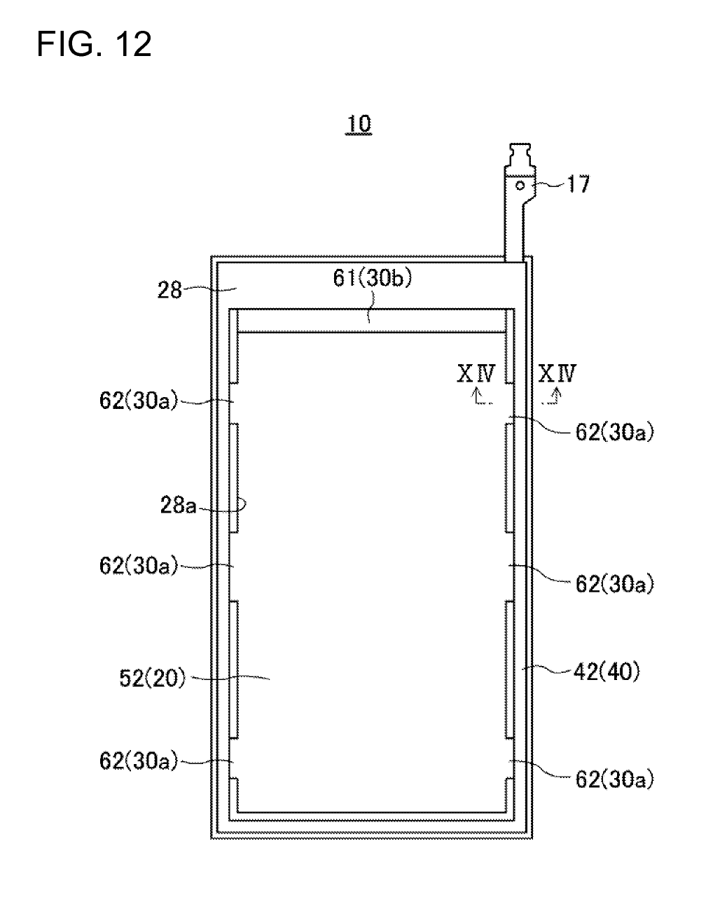

FIGS. 12 to 16 show Embodiment 3 of the present invention.

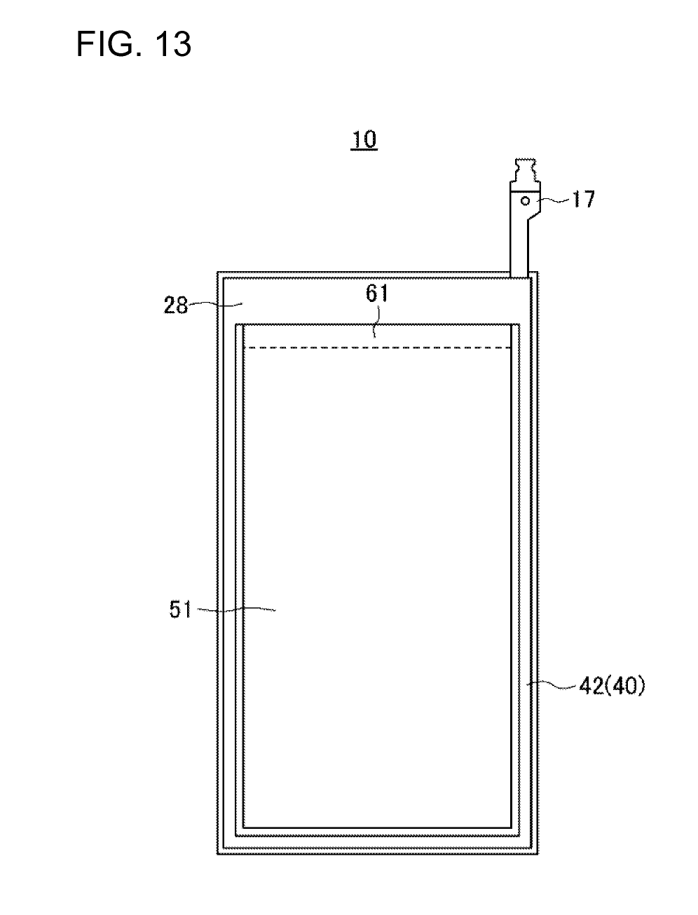

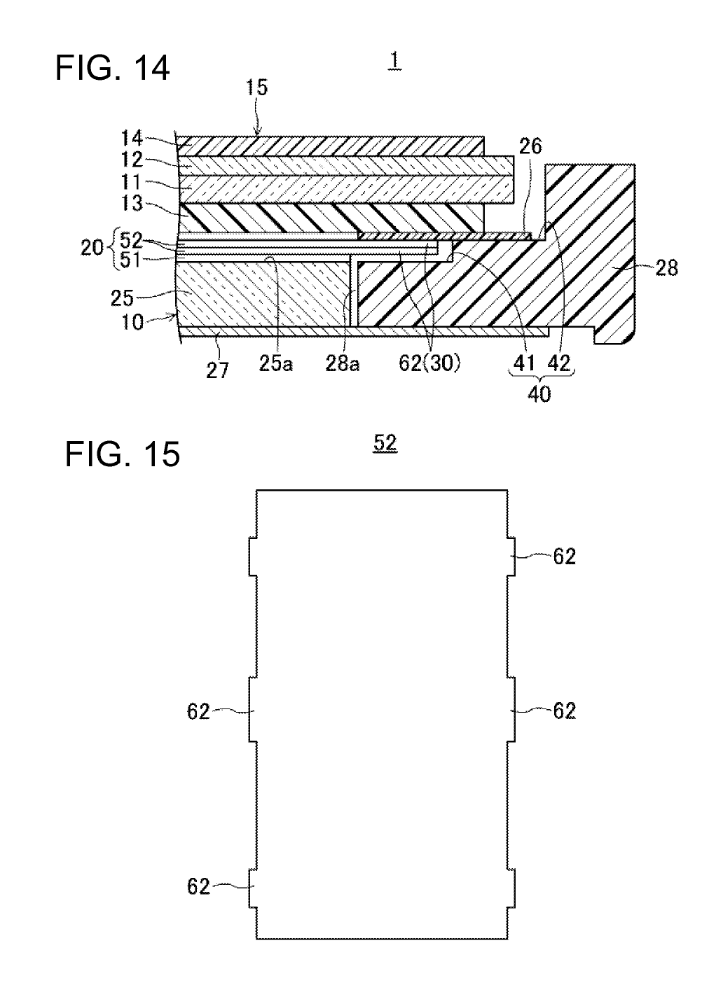

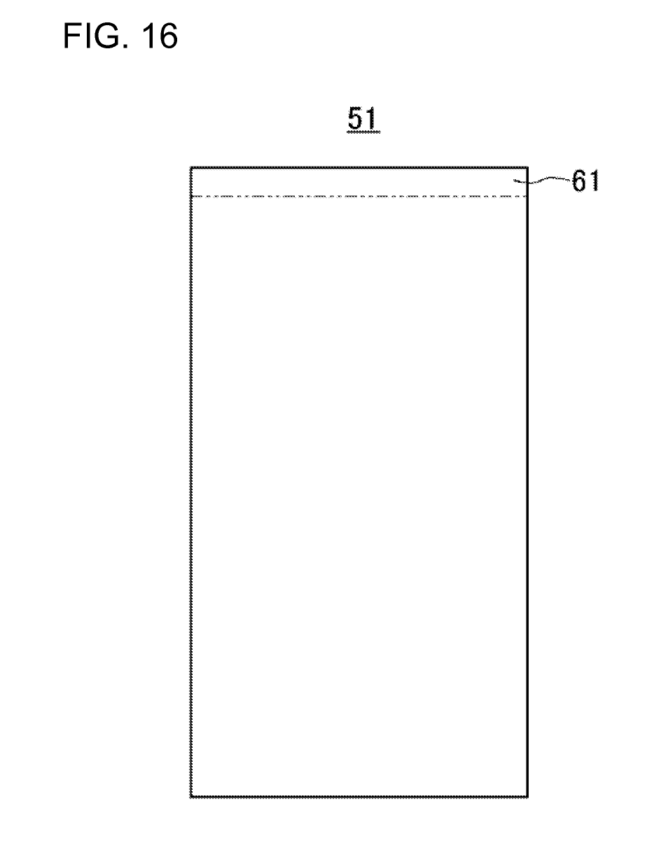

FIG. 12 is a plan view showing a sheet section 20 secured to a frame 28 in Embodiment 3. FIG. 13 is a plan view showing a first optical sheet 51 secured to the frame 28 in Embodiment 3. FIG. 14 is a cross-sectional view along the line XIV-XIV in FIG. 12. FIGS. 15 and 16 are plan views showing configurations of optical sheets 51 and 52.

Embodiment 2 differs from the liquid crystal display device 1 and the backlight unit 10 in Embodiment 1 in that the configuration of the sheet section 20 has been changed.

As shown in FIG. 14, a sheet section 20 of the present embodiment has one first optical sheet 51 and two second optical sheets 52, for example. As shown in FIGS. 15 and 16, the first and second optical sheets 51 and 52 are each substantially rectangular. As shown in FIGS. 13 and 14, the first optical sheet 51 is placed on a light-exiting surface 25a of a light guide plate 25. As shown in FIGS. 12 to 14, the two second optical sheets 52 are placed on top of the first optical sheet 51 while stacked together.

As shown in FIG. 12, secured parts 30 of the sheet section 20 include first secured parts 30a formed on each of two long-sides facing each other on the sheet section 20, and a second secured part 30b formed on one short-side of the sheet section 20. The first secured parts 30a include two second projections 62, and the second secured part 30b includes one first projection 61. The width of second secured part 30b along the sheet section 20 is greater than the width of the first secured parts 30a.

The plurality of optical sheets 51 and 52 each have either the second projections 62 constituting the first secured parts 30a or the first projection 61 constituting the second secured part 30b. In other words, as shown in FIG. 16, the first optical sheet 51 has the first projection 61 on one short-side. The first projection 61 is formed on the entire one short-side of the first optical sheet 51. As shown in FIG. 15, the second optical sheet 52 has a plurality of the second projections 62 formed on long-sides of the second optical sheet 52 facing each other.

As shown in FIG. 14, the secured parts 30 of the sheet section 20 are supported by first support surfaces 41 of the frame 28. The sheet section 20 is secured to the frame 28 at the secured parts 30 by a double-sided adhesive tape 26.

### Effects of Embodiment 3

Accordingly, Embodiment 3 can also suppress warping of the sheet section 20 due to thermal expansion while suitably maintaining a securing strength for the frame 28 of the sheet section 20, due to the sheet section 20 being secured to the frame 28 at the plurality of secured parts 30a and 30b. The number of projections 61 and 62 on the first and second optical sheets 51 and 52 included in each of the first secured parts 30a and second secured parts 30b is fewer than the number of optical sheets 51 and 52 constituting the entire sheet section 20, resulting in a smaller degree of transmitted light that is lost at the respective secured parts 30a and 30b, and making it possible to suppress a reduction in brightness of transmitted light in the vicinity of these secured parts 30a and 30b. Thus, dark spots can be prevented from occurring in the vicinity of the secured parts 30a and 30b, and uniform light can be emitted from the backlight unit 10. In this way, the display quality of a liquid crystal display device 1 can be increased.

Furthermore, the first optical sheet 51 that has the first projection 61 forming the second secured part 30b has the first projection 61 secured to a short-side of the sheet section 20, but not secured to the long-side, thereby making it possible to allow more thermal expansion with ease in the lengthwise direction, which is susceptible to large increases in size.

### Embodiment 4

Embodiments 1 and 2 differ from Embodiment 4 in that the configurations described in Embodiments 1 and 2 had an equal number of projections 31, 32, and 33 included in the respective secured parts 30 on the sheet section 20, whereas secured parts 30 in Embodiment 4 do not have an equal number of projections 31, 32, and 33.

An optical pattern (not shown) is formed on a light-exiting surface 25a of a light guide plate 25, but the brightness of the light exiting the light-exiting surface 25a may have an uneven distribution. As a countermeasure, the number of projections 31, 32, and 33 that form respective secured parts 30 in the present embodiment is increased or decreased in accordance with the brightness of the light emitted from the light guide plate 25 in the vicinity of where the secured parts 30 are arranged.

In other words, the lower the brightness of the light emitted from the light guide plate 25 in the vicinity of where the secured parts 30 are arranged is, the fewer number of projections 31, 32, 33 that form the secured parts 30 there are.

Therefore, according to the present embodiment, warping of the sheet section 20 due to thermal expansion can be suppressed while suitably maintaining a securing strength for a frame 28 of the sheet section 20, in a similar manner to Embodiments 1 and 2 described above. The number of projections 31, 32, and 33 on the optical sheets 21, 22, and 23 included in each of the secured parts 30 is fewer than the number of optical sheets 21, 22, and 23 forming the entire sheet section 20, resulting in being able to prevent the occurrence of dark spots in the vicinity of the secured parts 30 and being able to emit uniform light from the backlight unit 10.

Even if the brightness distribution of the light emitted from the light guide plate 25 is uneven, it is possible to more suitably prevent dark spots from occurring in the vicinity of the respective secured parts 30 because the number of projections 31, 32, and 33 forming the secured parts 30 in areas with low brightness is fewer than other areas. As a result, the display quality of a liquid crystal display device 1 can be more preferably increased.

### Other Embodiments

In the embodiments described above, an example in which three optical sheets form the sheet section 20, for example, was described, but the sheet section 20 may include a plurality of optical sheets, or the sheet section 20 can include 2 to 5 optical sheets, for example.

In the embodiments described above, the secured parts 30 of the sheet section 20 were formed by a plurality of mutually overlapping projections 31, 32, and 33, but the present invention is not limited thereto, and the secured parts 30 may also be formed by single projections 31, 32, and 33. This allows for a further decrease in the degree of light that is lost at the vicinity of the secured parts 30.

The present invention is not limited to Embodiments 1 to 3 described above, and any appropriate modifications of these Embodiments 1 to 4 are also included in the present invention.

### INDUSTRIAL APPLICABILITY

As described above, the present invention is useful for an illumination device and a liquid crystal display device provided therewith.

### DESCRIPTION OF REFERENCE CHARACTERS

1 liquid crystal display device

10 backlight unit (illumination device)

15 liquid crystal display panel

20 sheet section

21 first optical sheet

22 second optical sheet

23 third optical sheet

25 light guide plate

25a light-exiting surface

26 double-faced adhesive tape

28 frame

28a opening

30 secured part

30a first secured part

30b second secured part

31 first projection

32 second projection

33 third projection

51 first optical sheet

52 second optical sheet

61 first projection

62 second projection

1. An illumination device, comprising:
a light guide plate that has a light-exiting surface from which guided light exits;
a sheet section that is arranged on the light-exiting side of the light guide plate and that has a plurality of optical sheets stacked together; and
a frame that holds the sheet section and light guide plate,
wherein each optical sheet has projections that project over the light-exiting surface of the light guide plate towards a direction along a surface of the respective optical sheet,
wherein the sheet section has a plurality of secured parts each including one of the projections or a plurality of the projections overlapping each other, the sheet section being secured to the frame at the respective secured parts by a fixing member provided on a side of the sheet section opposite to the light guide plate, and
wherein a number of projections constituting the respective secured parts is fewer than a number of optical sheets constituting the sheet section.

2. The illumination device according to claim 1,
wherein the fixing member has a reflective layer that reflects light passing through the sheet section.

3. The illumination device according to claim 1,
wherein the fixing member is a white double-faced adhesive tape.

4. The illumination device according to claim 1,
wherein each of secured part has the same number of projections.

5. (canceled)

6. The illumination device according to claim 1,
wherein the sheet section is rectangular,
wherein the secured part has a first secured part formed on each of two long-sides that face each other on the sheet section, and a second secured part formed on one of two short-sides on the sheet section, and
wherein each optical sheet has either a projection constituting the first secured part or a projection constituting the second secured part.

7. The illumination device according to claim 6,
wherein a width of the second secured part along the sheet section is greater than a width of the first secured part.

8. A liquid crystal display device, comprising:
a liquid crystal display panel; and
an illumination device arranged facing the liquid crystal display panel,
wherein the illumination device includes: a light guide plate that has a light-exiting surface from which guided light exits; a sheet section that is arranged on the light-exiting side of the light guide plate and that has a plurality of optical sheets stacked together; and a frame that holds the sheet section and light guide plate,
wherein each optical sheet has projections that project over the light-exiting surface of the light guide plate towards a direction along a surface of the respective optical sheet,
wherein the sheet section has a plurality of secured parts each comprising one of the projections or a plurality of the projections overlapping each other, the sheet section being secured to frame at the respective secured parts by a fixing member provided on a side of the sheet section opposite to the light guide plate, and
wherein a number of projections constituting the respective secured parts is fewer than a number of optical sheets constituting the sheet section.

9. The liquid crystal display device according to claim 8,
wherein the fixing member has a reflective layer that reflects light passing through the sheet section.

10. The liquid crystal display device according to claim 8,
wherein the fixing member is a white double-faced adhesive tape.

11. The liquid crystal display device according to claim 8,
wherein each secured part has the same number of projections.

12. (canceled)

13. The liquid crystal display device according to claim 8,
wherein the sheet section is rectangular,
wherein the secured parts include a first secured part formed on each of two long-sides that face each other on the sheet section, and a second secured part formed on one of two short-sides on the sheet section, and
wherein each optical sheet has either a projection constituting the first secured part or a projection constituting the second secured part.

14. The liquid crystal display device according to claim 13,
wherein a width of the second secured part along the sheet section is greater than a width of the first secured part.

15. A liquid crystal display device, comprising:
a liquid crystal display panel; and
an illumination device arranged facing the liquid crystal display panel,
wherein the illumination device includes: a light guide plate that has a light-exiting surface from which guided light exits; a sheet section that is arranged on the light-exiting side of the light guide plate and that has a plurality of optical sheets stacked together; and a frame that holds the sheet section and light guide plate,
wherein each optical sheet has projections that project over the light-exiting surface of the light guide plate towards a direction along a surface of the respective optical sheet,
wherein the sheet section has a plurality of secured parts each comprising one of the projections or a plurality of the projections overlapping each other, the sheet section being fixed to the liquid crystal display panel at the respective secured parts by a fixing member provided on a side of the sheet section opposite to the light guide plate, the liquid crystal display panel fixed to the frame by the fixing member, and
wherein a number of projections constituting the respective secured parts is fewer than a number of optical sheets constituting the sheet section.
